(19) United States
(12) Patent Application Publication
(10) Pub. No.: US 2022/0051209 A1
(43) Pub. Date: Feb. 17, 2022

(54) AUTONOMOUS MOBILE BANKING

(71) Applicant: Wells Fargo Bank, N.A., San Francisco, CA (US)

(72) Inventors: H. Brock Kolls, Alpharetta, GA (US); Jasvir K. Singh, Columbia Heights, MN (US)

(21) Appl. No.: 15/633,280

(22) Filed: Jun. 26, 2017

(51) Int. Cl. G06Q 20/10; G07F 19/00; G05D 1/02; G05D 1/00

(52) U.S. Cl. CPC G06Q 20/1085; G07F 19/205; G05D 2201/0213; G05D 1/0088; G05D 1/021

(57) ABSTRACT

A mobile banking system and method include autonomously driving an autonomous vehicle including an automated teller machine (ATM) to a first transaction location, and conducting a first banking transaction at the first transaction location where cash is received by or dispensed from the ATM. Thereafter, a cash amount contained in the ATM is determined, a second transaction location is determined based on the cash amount contained in the ATM.

### BACKGROUND

Many businesses, such as retail businesses, are required to handle cash. Some assortment of cash denominations must be kept on hand for business tasks such as making change. Cash supplies must be periodically replenished to have the desired cash on hand. Further, businesses often prefer not to keep excessive amounts of cash on their premises, requiring depositing cash at a financial institution such as a bank from time to time. Especially for small businesses, replenishing and depositing cash requires repeated trips to the bank, which is time consuming, uses personnel resources, and could even potentially be dangerous.

### SUMMARY

In accordance with certain aspects of the present disclosure, examples of mobile autonomous banking methods and systems include an autonomous vehicle that has an automated teller machine (ATM). A computer system includes a memory accessible by a processor, with the memory storing program instructions that configure the processor to control the ATM to conduct a first banking transaction at a first transaction location, including at least one of receiving cash and dispensing cash. Following the first transaction, a cash amount contained in the ATM is determined, and based on the cash amount contained in the ATM, a second transaction location is determined. The ATM may then be driven by the autonomous vehicle to the second transaction location to conduct the second transaction.

In other examples, a plurality of banking transaction requests are received from a plurality of transaction locations. An autonomous vehicle including an ATM is autonomously driven to a first transaction location, and a first banking transaction is conducted at the first transaction location. The first transaction includes at least one of receiving cash and dispensing cash. Thereafter, a cash amount contained in the ATM is determined, and a second transaction location is determined based on the cash amount contained in the ATM.

In still further examples, a mobile banking control system is configured to receive a request for a first banking transaction from a first transaction location. The system dispatches an autonomous vehicle including an ATM to the first transaction location, where the first banking transaction is conducted. The first transaction including at least one of receiving cash and dispensing cash. Following the first transaction, a cash amount contained in the ATM is determined, and a second transaction is determined location based on the cash amount contained in the ATM.

### DESCRIPTION OF THE DRAWINGS

FIG. 1 is a process flow diagram illustrating an example of a mobile banking method in accordance with aspects of the present disclosure.

FIG. 2 is a block diagram conceptually illustrating aspects of an example of an autonomous vehicle in accordance with aspects of the present disclosure.

FIG. 3 is a block diagram illustrating an example of a mobile banking system in accordance with aspects of the present disclosure.

FIG. 4 conceptually illustrates an example of transactions and transaction locations serviced by an autonomous vehicle having an ATM in accordance with aspects of the present disclosure.

FIG. 5 conceptually illustrates an example of a predetermined desired cash supply range for an ATM in accordance with aspects of the present disclosure.

FIG. 6 is a process flow diagram illustrating another example of a mobile banking method in accordance with aspects of the present disclosure.

FIG. 7 is a block diagram illustrating portions of an example computer system.

### DETAILED DESCRIPTION

In the following Detailed Description, reference is made to the accompanying drawings, which form a part hereof, and in which is shown by way of illustration specific embodiments in which the invention may be practiced. The following detailed description, therefore, is not to be taken in a limiting sense.

Businesses, such as retail businesses, often are required to keep some amount of cash on site. For instance, some assortment of cash denominations must be kept on hand making change during purchase transactions. Cash supplies must be periodically replenished to have the desired cash on hand. At the end of some business periods, such as at the end of a business day, cash is often transported off of the business site for deposit at a financial institution such as a bank. Further, businesses often prefer not to keep excessive amounts of cash on their premises, requiring depositing cash at the financial institution at additional times. Thus, managing cash supplies can require repeated trips to the bank, which is time consuming, uses personnel resources, and could even potentially be dangerous.

The present disclosure generally relates to mobile banking systems and processes that are facilitated by an autonomous vehicle that is equipped with an automated banking teller (ATM). As used herein, an autonomous vehicle refers to a vehicle that can detect its surroundings and navigate with little or no human input. Techniques such as radar, a global positioning system (GPS) and computer vision can be used to navigate the autonomous vehicle.

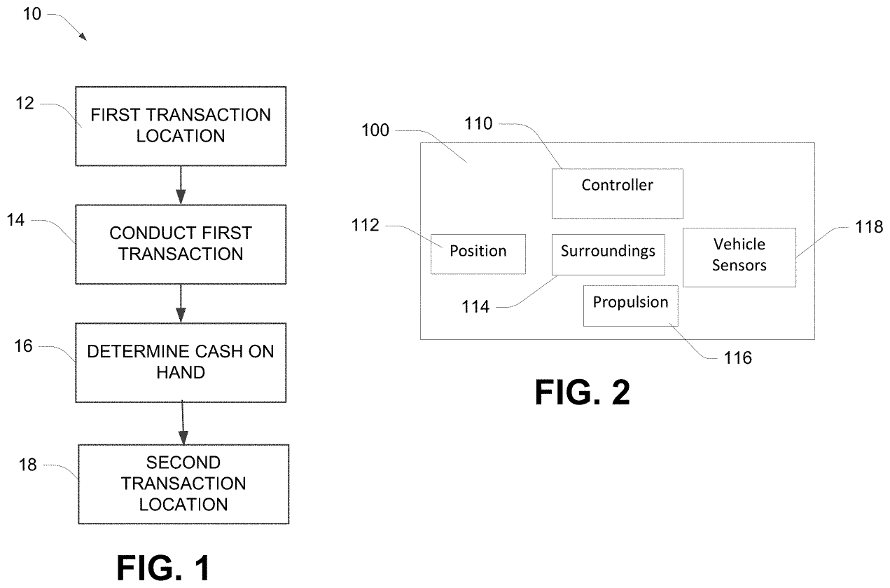

FIG. 1 illustrates aspects of a mobile banking process 10 in accordance with examples disclosed herein. The ATM-equipped autonomous vehicle is dispatched to a first transaction location as indicated in block 12. The ATM facilitates conducting a first banking transaction at the first transaction location in block 14. The banking transaction indicated in block 14 includes receiving cash and/or dispensing cash. For example, if a business needs a daily supply of currency for making change, the transaction would include dispensing some combination of cash and coins for making change. At the end of the business day, for example, the transaction at block 14 could include receiving cash when the business owner deposits cash from the day's sales.

Upon completion of the transaction at block 14, the amount of cash contained in the ATM is determined as shown in block 16. Based on the determined cash on hand in the ATM, a second transaction location is determined in block 18.

Thus, rather than requiring the business owner to go to the bank, the bank autonomously comes to the business owner. As noted above, the ATM function is transported using an autonomous vehicle, which is operated with little or no input from a human driver. FIG. 2 is a block diagram illustrating aspects of an example autonomous vehicle 100, which includes a vehicle controller 110 that operates the autonomous vehicle 100. The example autonomous vehicle 100 is a self-driving vehicle, which has enhanced security features for safely transporting the ATM and the cash contained therein. The controller 110 provides instructions in the form of control signals (such as driving and stopping signals) to the appropriate components of the autonomous vehicle 100. The controller 110 includes a positioning device 112 that can receive and transmit position data to the controller 110. The location of the vehicle 100 at any given time can be determined by the positioning device 112 or another appropriate positioning system. Examples of such positioning devices 112 include GPS systems and devices. The vehicle controller 110 further includes a surroundings detection system 114 configured to detect the surroundings of the vehicle 100 by appropriate detection systems such as radar, laser light, GPS, odometry, computer vision, etc. The controller 110 is configured to interpret location, surroundings, and other sensory information such as from various vehicle sensors 118 to identify appropriate navigation paths, as well as obstacles and relevant driving information, and output control signals to a propulsion system 116 that includes appropriate components (energy, propulsion, transmission, steering, etc.) for driving the vehicle 100.

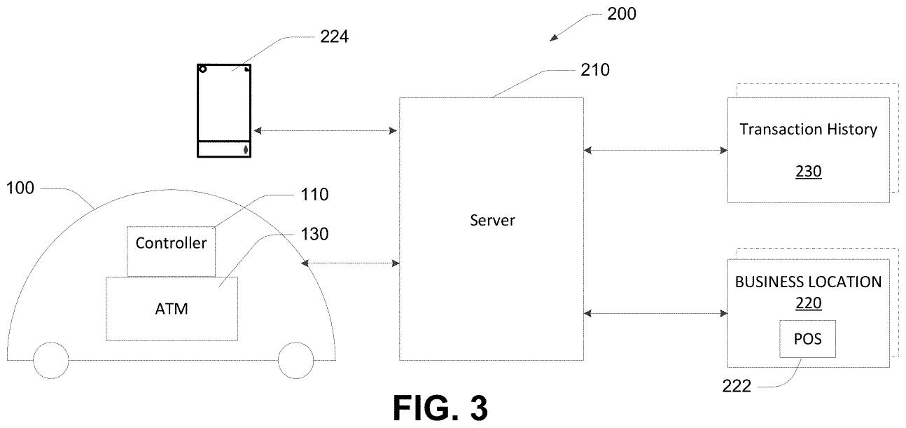

FIG. 3 illustrates aspects of an example autonomous mobile banking system 200. The system 200 includes the autonomous vehicle 100 and controller 110, which could be implemented by any suitable computing device including a processor, memory, and associated components. The autonomous vehicle 100 houses an ATM 130.

A server computer 210 communicates with the autonomous vehicle 100 and the ATM 130. The server 210 may be a server computer at a bank or other financial institution. In some implementations, functions of the server computer 210 are implemented by the controller 110. The server computer 210 is accessible from the ATM 130 and processes transactions at the ATM 130. Information relating to financial transactions from the ATM 130, as well as other ATM and autonomous vehicle information may be transmitted to the server computer 210, such as over a network such as the internet. Financial information and other information generated by the server computer 210 may also be transmitted to the autonomous vehicle 100 and the ATM 130.

Both the controller 110 and the server computer 210 include a processor and a memory accessible by the processor storing program instructions that configure the computer corresponding computers to implement various processes disclosed herein. In some examples, the server 210 can be one of a network of servers (e.g., a “cloud”) of the system 200. Further, each server in the network of servers can be adapted to perform a specific function or functions on behalf of the system 200. Although specific functionalities will be attributed to the server 210 (and/or controller 110) in this disclosure, it should be appreciated that the same functionalities can be divided among a network of interconnected servers. Thus, throughout this disclosure, the server 210 can alternatively be understood as a single server or a network of servers.

As discussed further below, the server computer 210 communicates with various devices and databases, including business locations 220 and point of sale (POS) systems 222 associated therewith, user devices such as smart phones 224 and other user computer devices, and databases 230 storing, for example, banking transaction history data 232

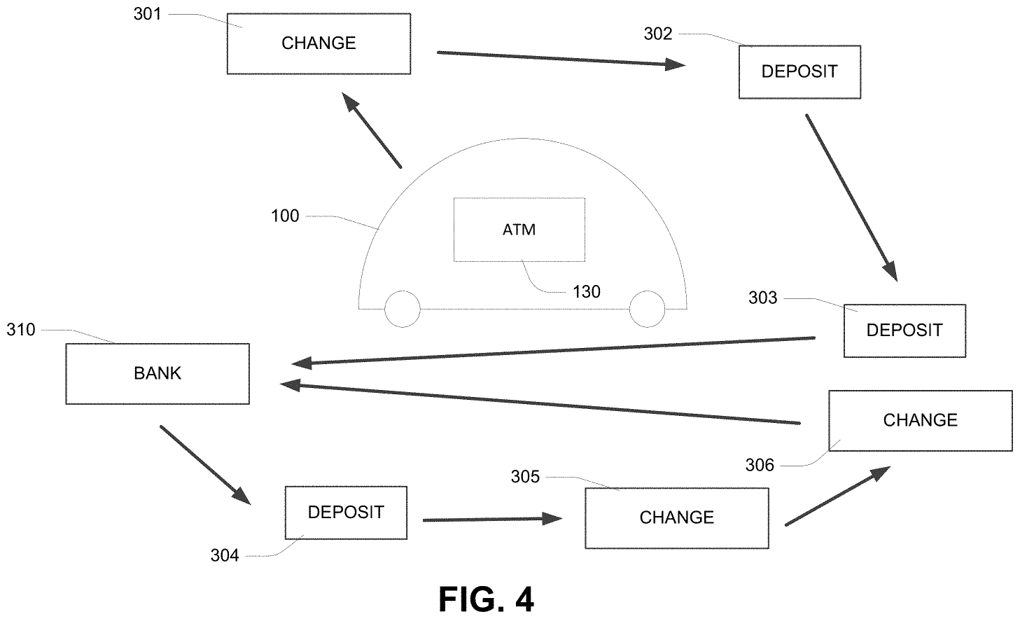

FIG. 4 conceptually illustrates various transactions and transaction locations serviced by the autonomous vehicle 100 and ATM 130. In the illustrated example, the ATM 130 conducts banking transactions, such as bringing cash to various businesses and/or receiving cash deposits from the businesses. Various banking transaction requests are received by the ATM 130, either directly or via the server computer 210. The banking transactions may be directly generated by a business owner such as by his or her mobile phone or other computing device, from POS systems associated with businesses. In some implementations, transaction requests may also be automatically generated such as via analysis by the computer 210 of transaction information such historical transaction data, or transactions associated with other, possibly similar businesses.

In the example of FIG. 4, transaction requests have been received and a route for the autonomous vehicle 100 to travel from one transaction location to another is shown. Typically, the ATM 130 would be pre-stocked with cash so that the ATM 130 starts the route with some predetermined amount of cash on hand. The illustrated transactions include providing change (cash) and receiving cash deposits at transaction locations 301-306. Additionally, a financial institution such as a bank 310 is included. Thus, the autonomous vehicle 100 could transport the ATM 130 to transaction locations 301, 302, and 303 to conduct the indicated banking transactions.

More particularly, at the transaction location 301, a “change” transaction is conducted, in which cash is dispensed from the ATM 130, for example, to be used to make change for purchases at a business located at transaction location 301. This depletes some of the cash supply contained the ATM 130. The autonomous vehicle 100 then proceeds to transaction location 302 with the ATM to conduct a deposit transaction in which cash is received by the ATM 130, thus increasing the amount of cash contained in the ATM 130. Continuing, the autonomous vehicle 100 then proceeds to transaction location 303 to service a second deposit transaction. This second deposit transaction again increases the cash supply on the ATM 130.

Following the deposit transaction at transaction location 303, the autonomous vehicle 100 takes the ATM 130 to the bank 310 such that cash may be removed from and/or received by the ATM 130. For example, if the amount of cash contained in the ATM 130 exceeds some predetermined level, the ATM is taken to the bank 310 such that the excess cash may be removed from the ATM 130 and deposited in the bank 310. Since a typical transaction request could include receiving certain cash denominations for making change at the businesses, a trip to the bank 310 may be also necessary to stock the ATM 130 with the proper cash denominations. Similarly, if the total amount of cash contained in the ATM 130 drops below some desired level, the ATM 130 would be returned to the bank 310 to receive additional cash.

After the ATM 130 is autonomously driven to the bank 310 and the cash contained in the ATM 130 is adjusted, the indicated banking transactions are conducted at transaction locations 304, 305, 306. Upon completion of the last transaction at location 306, the autonomous vehicle 100 again returns to the bank 310.

In accordance with some examples, the route taken by the autonomous vehicle 100 is determined or altered in real time, based on the amount of cash contained in the ATM 130. For instance, the amount of cash contained in the ATM 130 may be compared to a desired cash supply range for the ATM 130, and based on the comparison, subsequent transaction location(s) are determined.

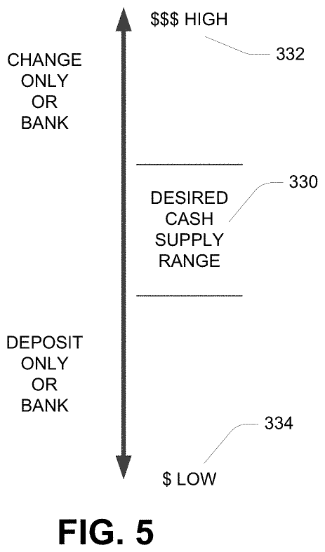

An example of such a process is illustrated in FIG. 5, where the amount of cash included in the ATM 130 is compared to a desired cash supply range 330. If the amount of cash contained in the ATM 130 is within the desired cash supply range 130, transactions in which the ATM receives or dispenses cash may be conducted. Thus, a second transaction location may be determined based on any suitable criteria, such as the transaction location closest to the autonomous vehicle's 100 current location, priority levels set by the customer, etc.

If the determined cash amount contained in the ATM 130 is greater than the desired cash supply range 330, the ATM 130 contains too much cash as indicated at the upper end 332 of the arrow shown in FIG. 5. In this situation, the ATM 130 is autonomously driven by the autonomous vehicle 100 to the bank 310 where cash may be deposited to the bank 310 from the ATM 100. Alternatively, subsequent transaction locations could include only those where cash is dispensed from the ATM 130, such that the cash supply in the ATM 130 is reduced.

On the other hand, if the determined cash amount contained in the ATM 130 is less than the desired cash supply range 330 as indicated at the lower end 334 of the arrow shown in FIG. 5, the cash contained in the ATM 130 is too low. Accordingly, the ATM 130 is autonomously driven by the autonomous vehicle 100 to the bank 130 to withdraw cash from the bank 330 for the ATM 130. Alternatively, subsequent transaction locations could include only those where cash is received by the ATM 130, such that the cash supply in the ATM 130 is increased.

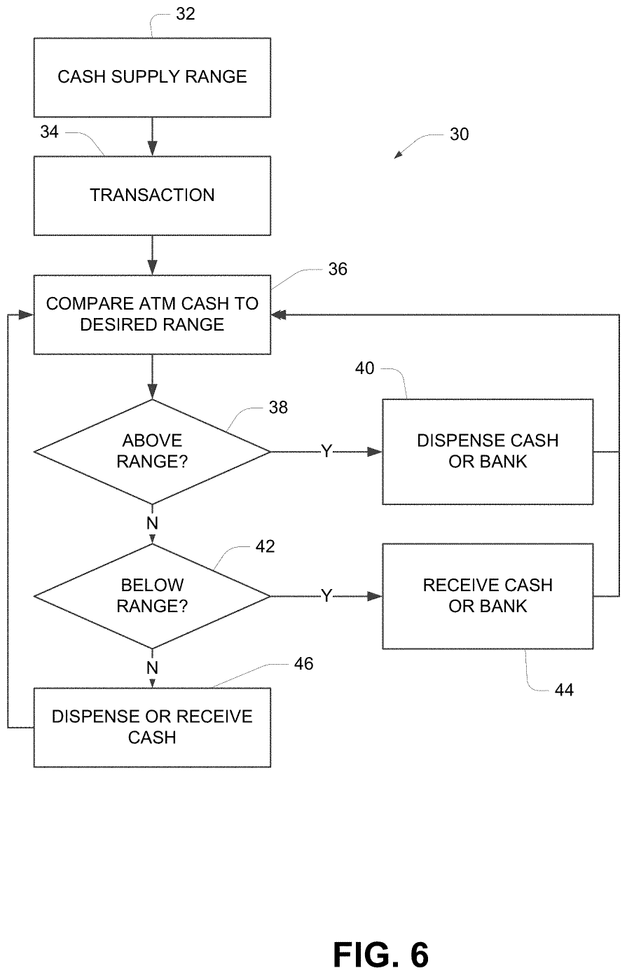

FIG. 6 is a flow chart illustrating an example process 30 for determining subsequent transactions. In block 32, the desired cash supply range 330 is determined. This range 330 may be stored in any suitable memory device accessible by the server computer 210, the ATM 130, the controller computer 110, etc. as appropriate. Upon completion of a banking transaction at a transaction location in block 34, the amount of cash contained in the ATM 130 is determined and compared to the desired cash range 330 in block 36. If the cash contained in the ATM 130 is above the predetermined cash range 330 as determined in decision block 38, then only transactions where cash is dispensed are conducted in block 40. This reduces the amount of cash contained in the ATM 130. Alternatively, the ATM 130 may be transported to the bank by the autonomous vehicle 100 such that cash can be removed from the ATM 130 and deposited in the bank. Once the transaction indicated in block 40 is complete, the process returns to comparing the cash contained in the ATM 130 to the desired cash range at block 36 to determine the next transaction.

If the cash contained in the ATM 130 is below the predetermined cash range 330 as determined in decision block 42, then only transactions where cash is received are conducted in block 44. This increases the amount of cash contained in the ATM 130. Alternatively, the ATM 130 may be transported to the bank by the autonomous vehicle 100 such that cash can be received by the ATM 130 from the bank. Once the transaction indicated in block 44 is complete, the process returns to comparing the cash contained in the ATM 130 to the desired cash range at block 36 to determine the next transaction.

If the amount of cash contained in the ATM 130 is within the desired cash range 330 (not above the range in block 38 or below the range in block 42), then transactions where cash is either received or dispensed from the ATM 130 may be conducted as shown in block 46. In such instances, the subsequent transaction location could be determined according to other criteria, such as geographic proximity, customer priority, transaction amount, etc. Once the transaction indicated in block 46 is complete, the process returns to comparing the cash contained in the ATM 130 to the desired cash range at block 36 to determine the next transaction.

In some implementations, a preliminary route to several transaction locations is determined prior to conducting the transactions. For example, several factors could be considered to determine the preliminary route, such as transaction history for the particular times and dates, customer transaction history, geographical locations of the customers to be serviced, estimated transaction amounts, etc. FIG. 4 could be preliminarily determined based on factors such as those just mentioned. After conducting the first transaction at the first transaction location 301, the cash contained in the ATM 130 is determined, and based on that determination, the autonomous vehicle 100 would proceed either to the next preliminarily scheduled transaction location 302, or to an alternative second transaction location. For example, if the amount of cash contained in the ATM 130 is greater than the predetermined cash range 330 as described in the process shown in FIG. 6, the autonomous vehicle 100 alternatively transport the ATM 130 to the transaction location 306 and conduct a transaction where cash is dispensed from the ATM 130. The process of determining subsequent transactions would then continue following that transaction.

Referring again to FIG. 4, the illustrated example shows the bank 310 located along the transaction route for the autonomous vehicle 100. In some examples, there may be more than one bank located in the area serviced by the autonomous vehicle. In such implementations, the server 210 and/or autonomous vehicle 100 may be configured to determine which bank to use for restocking or removing cash from the ATM 130. For instance, the bank location closest to the current transaction location could be selected. Moreover, some examples allow the desired cash range 330 to be adjusted (e.g. by the server 210) if necessary. If the autonomous vehicle is located too far from the bank 310, or time constraints would preclude returning to the bank 310, the cash range 330 could be adjusted to allow the ATM 130 to conduct additional transactions.

In some examples, banking transactions in addition to dispensing and receiving cash are conducted. For instance, loan papers, credit card replacements, forms requiring signature, etc. may be delivered and/or collected from customers at various transaction locations.

As noted above, the server computer 210 and/or the controller 110 may be configured to communicate with POS systems 222 at businesses 220 serviced by the ATM 130. Such POS systems 222 typically keep track of cash on hand at the business locations, and may be configured to notify the server 210 and/or the autonomous vehicle 100 when change or a deposit is necessary. In some examples, the POS system 222 is configured to keep track of autonomous vehicle's 100 location via GPS to estimate arrival timing of the ATM 130.

As noted above, the system can manage the desired cash supply balance by using artificial intelligence/machine learning to route plan based on historical transaction data of the banking customers on the route. In this regard, knowing historically who and how much to expect in customer transactions, the autonomous vehicle can select which of the customer banking transaction requests to service first and in which order to keep the ATM cash supply balance in the desired range.

Thus, some disclosed examples improve security and safety by ensuring the ATM 130 does not have too much cash on hand within the autonomous vehicle 100. Additionally, by determining or adjusting the transaction location route in real time based on the amount of cash contained in the ATM, the number of customer stops could be maximized while minimizing trips back to the bank add or remove cash from the ATM 130. This allows fewer autonomous vehicles/ATMs service more customers in a timely manner.

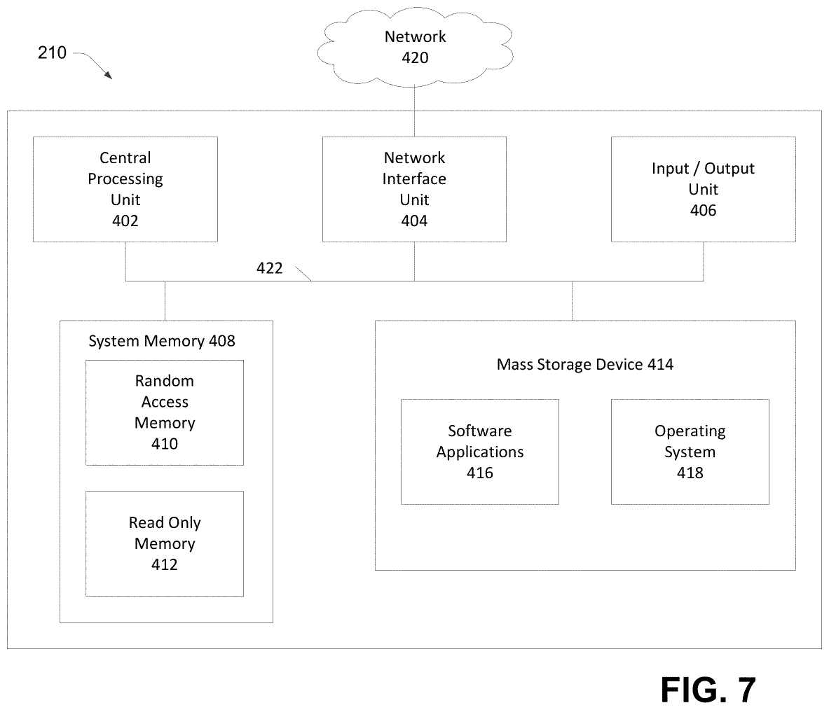

FIG. 7 schematically illustrates an example of the computer 210, which could be a server computer at a financial institution as discussed above. The controller 110 of the autonomous vehicle 100, as well as a processor for the ATM 130 could have similar structures. The computer 102 includes at least one processor (“CPU”) 402, a system memory 408, and a system bus 422 that couples the system memory 408 to the CPU 402. The system memory 408 includes a random access memory (“RAM”) 410 and a read-only memory (“ROM”) 412. A basic input/output system that contains the basic routines that help to transfer information between elements within the server computer 210, such as during startup, is stored in the ROM 412. The server computer 210 further includes a mass storage device 414. The mass storage device 414 is able to store software instructions and data. As noted above, the user accounts 106 could be stored in a database implemented by the mass storage device 412, and could further include additional databases implemented by other computer systems accessible by the server 210. A processor, system memory and mass storage device similar to that in FIG. 7 are also included in the controller 110.

The mass storage device 414 is connected to the CPU 402 through a mass storage controller (not shown) connected to the system bus 422. The mass storage device 414 and its associated computer-readable data storage media provide non-volatile, non-transitory storage for the server computer 210. Although the description of computer-readable data storage media contained herein refers to a mass storage device, such as a hard disk or solid state disk, it should be appreciated by those skilled in the art that computer-readable data storage media can be any available non-transitory, physical device or article of manufacture from which the central display station can read data and/or instructions.

Computer-readable data storage media include volatile and non-volatile, removable and non-removable media implemented in any method or technology for storage of information such as computer-readable software instructions, data structures, program modules or other data. Example types of computer-readable data storage media include, but are not limited to, RAM, ROM, EPROM, EEPROM, flash memory or other solid state memory technology, CD-ROMs, digital versatile discs (“DVDs”), other optical storage media, magnetic cassettes, magnetic tape, magnetic disk storage or other magnetic storage devices, or any other medium which can be used to store the desired information and which can be accessed by the server computer 210.

According to various embodiments of the invention, the server computer 210 may operate in a networked environment using logical connections to remote network devices through the network 420, such as a wireless network, the Internet, or another type of network. The server computer 210 may connect to the network 420 through a network interface unit 404 connected to the system bus 422. It should be appreciated that the network interface unit 404 may also be utilized to connect to other types of networks and remote computing systems. The server computer 210 also includes an input/output controller 406 for receiving and processing input from a number of other devices, including a touch user interface display screen, or another type of input device. Similarly, the input/output controller 406 may provide output to a touch user interface display screen or other type of output device.

As mentioned briefly above, the mass storage device 414 and the RAM 410 of the server computer 210 can store software instructions and data. The software instructions include an operating system 418 suitable for controlling the operation of the server computer 210. The mass storage device 414 and/or the RAM 410 also store software instructions, that when executed by the CPU 402, cause the server computer 210 to provide the functionality of the server computer 210 discussed in this document. For example, the mass storage device 414 and/or the RAM 410 can store software instructions that, when executed by the CPU 402, cause the server computer 210 to implement the various processes described herein, among other things.

Although various embodiments are described herein, those of ordinary skill in the art will understand that many modifications may be made thereto within the scope of the present disclosure. For instance, examples related to home loans are included herein, though the disclosed systems and methods are also applicable to many other financial processes, such as personal and business loans, credit card accounts, home equity lines of credit, mortgage refinances, etc. Accordingly, it is not intended that the scope of the disclosure in any way be limited by the examples provided.

1-10. (canceled)

11. A mobile banking method, comprising:
receiving, using a server computer, a first transaction request from a first customer at a first transaction location;
autonomously driving an autonomous vehicle including an automated teller machine (ATM) including a cash dispensing device to the first transaction location;
conducting, using the ATM, a first banking transaction at the first transaction location, including
performing, using the cash dispensing device, at least one of receiving cash and dispensing cash;
determining, using the server computer, a cash amount contained in the ATM;
comparing, using the server computer, the cash amount to a desired cash supply range defining a desired amount of cash in the ATM;
receiving, using the server computer, a second banking transaction request for a cash withdrawal from the ATM by a second customer at a second transaction location;
receiving, using the server computer, a third transaction request for a cash deposit to the ATM by a third customer at a third transaction location;
subsequent to receiving the second transaction request and the third transaction request, and before completing each of the second transaction request and the third transaction request:
determining, using the server computer, a second transaction at either the second transaction location or the third transaction location based on the cash amount contained in the ATM, the second transaction being selected to increase or decrease the cash amount in the ATM based upon the desired cash supply range, including:
when the cash amount is greater than the desired cash supply range, selecting the second banking transaction request and the second transaction location for the second transaction;
when the cash amount is less than the desired cash supply range, selecting the third transaction request and the third transaction location for the second transaction; and
when the cash amount is within the desired cash supply range, selecting for the second transaction either the second transaction request and the second transaction location or the third transaction request and the third transaction location based on at least one of:
i) the proximity to the first transaction location to each of the second transaction location and the third transaction location; and
ii) a prioritization of the second customer and the third customer;
autonomously driving the autonomous vehicle including the ATM to the selected one of the second transaction location and the third transaction location to complete the second transaction;
adjusting, using the server computer, the desired cash supply range when time constraints preclude returning the autonomous vehicle to a financial institution; and
in response the adjusted desired cash supply range, conducting, using the ATM, an additional transaction.

12. (canceled)

13. The method of claim 11, further comprising, after completing the second transaction:
determining, using the server computer, the cash amount contained in the ATM; and
determining, using the server computer, a fourth transaction location based on the cash amount contained in the ATM.

14-15. (canceled)

16. The method of claim 11, further comprising determining, using the server computer, a preliminary route to the first transaction location.

17-20. (canceled)
